(19) United States
(12) Patent Application Publication
(10) Pub. No.: US 2025/0302702 A1
(43) Pub. Date: Oct. 2, 2025

(54) PACIFIER PUMP

(71) Applicant: Medernity Inc., Littleton, CO (US)

(72) Inventors: Amin AKHLAGHI, Great Falls, VA (US); Kyle Addison KNUPPEL, Littleton, CO (US)

(73) Assignee: Medernity Inc., Littleton, CO (US)

(21) Appl. No.: 18/623,789

(22) Filed: Apr. 1, 2024

(51) Int. Cl. A61J 17/00

(52) U.S. Cl. CPC A61J 17/10

(57) ABSTRACT

A pacifier pump system is described herein. The pacifier pump system generally includes a housing or hub defining a receiving channel and having a first valve and a second valve, wherein the housing or hub is configured to be removably coupled to an opening defined within a pacifier. A reservoir tubing may be fluidly coupled to the receiving channel through the first valve which is configured to enable flow from the reservoir tubing into the receiving channel. The system may further include a feed tubing fluid coupled to the receiving channel through the second valve which is configured to enable flow from the receiving channel into the feed tubing.

### FIELD OF THE INVENTION

The present invention relates to medical devices. In particular, the present invention relates to apparatus and methods for supporting the feeding of infants.

### BACKGROUND OF THE INVENTION

Some infants, particularly preterm infants, are susceptible to a number of conditions such as neurodevelopmental immaturity, physiologic instability, and behavioral state disorganization. Because of this, challenges often arise with successfully beginning oral feedings and achieving full oral intake which in turn may delay hospital discharge and considerably increase the cost of care. Feeding problems also may account for a significant portion of early readmissions for late preterm infants whereas successful breastfeeding has been found to be protective against hospital readmission among infants born at under 33 weeks gestation.

To ensure that the infant is receiving adequate nutrition, feeding through nasogastric or orogastric tubes is often used. However, the use of tube feeding often de-couples the association between sucking and feeding in the infant. Clinical experience suggests that sucking of a pacifier, in connection with tube feeding, can facilitate feeding. Nonnutritive sucking has also been shown to enhance the rate of weight gain in preterm infants as such effects may be related to an activation of vagal nerve activity via a stimulation of fibers in the oral cavity. Vagal activation is known to induce gastric receptive relaxation and to enhance the rate of gastric acid secretion and the rate of gastric emptying.

The use of a pacifier during tube feeding appears to be favorable as neurogenic mechanisms normally induced during oral feeding are activated by sucking. Hence, vagal activation induced by sucking stimulates secretory motor and endocrine processes in connection with feeding, which can lead to an optimized digestion and metabolism of the food ingested. The presence of a pacifier in the mouth of a bolus-fed infant also provides sensory information from the oral mucosa that may be of importance for a normal development of feeding behavior.

Aside from aiding the development of feeding behavior, the use of a pacifier may also provide a number of additional benefits such as facilitating gastric emptying and reducing feeding intolerance, reducing the occurrence of gastrointestinal damage, increasing levels of gastrin and somatostatin (which aid in acid secretion, optimal digestion, absorption of nutrients, and expulsion of waste products), reducing stress, as well as supporting immediate pain regulation and reducing pain reactivity.

Accordingly, there is a need for devices and methods which are able to take advantage of the use of a pacifier while maintaining the association of the sucking reflex with feeding in the infant.

### SUMMARY OF THE INVENTION

A pacifier pump system provide a self-actuated feeding mechanism for the infant which takes advantage of the sucking reflex of the infant. The pacifier pump systems also maintains or couples the association between the sucking reflex with the physiological mechanisms associated with feeding (e.g., breastfeeding).

One method of feeding an infant generally comprises fluidly coupling a housing or hub within an opening of a pacifier, fluidly coupling a reservoir tubing extending from the housing or hub to a fluid reservoir, fluidly coupling a feed tubing extending from the housing or hub to a gastric tube extending into the infant, and positioning the pacifier within a mouth of the infant, wherein a sucking motion provided by the infant upon a nipple of the pacifier actuates a fluid within the fluid reservoir to flow through the reservoir tubing, into the housing or hub, through the feed tubing, and into the gastric tube to provide the fluid to the infant.

In another aspect, the method includes fluidly coupling the housing or hub by inserting the housing or hub within the opening of the pacifier.

In another aspect, the method includes fluidly coupling the reservoir tubing by fluidly coupling through a first unidirectional valve which enables flow from the reservoir tubing into the housing or hub.

In another aspect, the method includes coupling the reservoir tubing by fluidly coupling the reservoir tube to a hub of a syringe.

In another aspect, the method includes fluidly coupling the feed tubing by fluidly coupling through a second unidirectional valve which enables flow from the housing or hub into the feed tubing.

In another aspect, the gastric tube comprises a nasogastric or orogastric tube.

In another aspect, the sucking motion provided by the infant comprises a compression and decompression of the nipple of the pacifier.

In another aspect, the method includes imparting a pressure upon the fluid.

Another method of associating feeding in an infant may generally comprise providing a pacifier positioned within a mouth of the infant, wherein the pacifier is fluidly coupled to a fluid reservoir and also to a gastric tube extending into the infant, providing a fluid within the fluid reservoir, wherein the fluid is actuated to flow from the fluid reservoir, through the pacifier, and to the gastric tube when the infant sucks upon the pacifier.

In another aspect, the method includes providing the pacifier by inserting a housing or hub within an opening of a pacifier.

In another aspect, the method includes fluidly coupling the pacifier to the fluid reservoir through a reservoir tubing.

In another aspect, the method includes fluidly coupling the reservoir tubing through a first unidirectional valve which enables flow from the reservoir tubing into the housing or hub.

In another aspect, the method includes fluidly coupling the reservoir tubing to a hub of a syringe.

In another aspect, the method includes fluidly coupling the pacifier to the gastric tube through a feed tubing.

In another aspect, the method includes fluidly coupling the feed tubing to the housing or hub through a second unidirectional valve which enables flow from the housing or hub into the feed tubing.

In another aspect, the gastric tube comprises a nasogastric or orogastric tube.

In another aspect, the sucking motion provided by the infant comprises a compression and decompression of a nipple of the pacifier.

In another aspect, the method includes imparting a pressure upon the fluid as the infant sucks upon the pacifier.

One variation of the pacifier pump system may generally comprise a housing or hub defining a receiving channel and having a first valve and a second valve, wherein the housing or hub is configured to be removably coupled to an opening defined within a pacifier, a reservoir tubing fluidly coupled to the receiving channel through the first valve which is configured to enable flow from the reservoir tubing into the receiving channel, and a feed tubing fluid coupled to the receiving channel through the second valve which is configured to enable flow from the receiving channel into the feed tubing.

In another aspect, the housing or hub forms an enclosure between the receiving channel and the opening defined within the pacifier.

In another aspect, the system includes a fluid reservoir which is removably attachable to the reservoir tubing.

In another aspect, the system includes a gastric tube which is removably attachable to the feed tubing.

In another aspect, the first valve comprises a unidirectional valve which enables unidirectional flow from the reservoir tubing into the receiving channel.

In another aspect, the second valve comprises a unidirectional valve which enables unidirectional flow from the receiving channel into the feed tubing.

In another aspect, the system includes a mechanism for imparting a pressure upon a fluid within the pacifier.

### BRIEF DESCRIPTION OF THE DRAWINGS

FIG. 1 shows a perspective assembly view of one variation of the pacifier pump system.

FIG. 2 shows a perspective view of one variation of the fluid transfer assembly.

FIGS. 3A and 3B show perspective views of the fluid transfer assembly removably inserted into a pacifier.

FIG. 4A shows a schematic side view of one variation for fluidly coupling the fluid transfer assembly to the pacifier.

FIG. 4B shows a schematic side view of another variation of the fluid transfer assembly incorporating an expandable channel within the pacifier.

FIG. 4C shows a schematic side view of another variation of the fluid transfer assembly in which the fluid tubing and valves are incorporated directly with the pacifier.

FIGS. 5A to 5C show one variation of how the pacifier may function as a pumping mechanism for moving fluid through the tubing.

FIG. 6 shows one example of how the pacifier pump system may be utilized for feeding an infant.

FIG. 7 shows a schematic view of yet another variation in which the fluid transfer assembly may incorporate a plunger or pumping mechanism.

### DETAILED DESCRIPTION OF THE INVENTION

A pacifier pump system may be used to maintain or couple the association between the sucking reflex in an infant with the physiological mechanisms associated with feeding (e.g., breastfeeding). Additionally, the use of a pacifier pump system by the infant may also directly provide a self-actuated feeding mechanism for the infant rather than requiring a multi-step process of providing a pacifier to an infant and separately feeding the infant through a separate tubing mechanism.

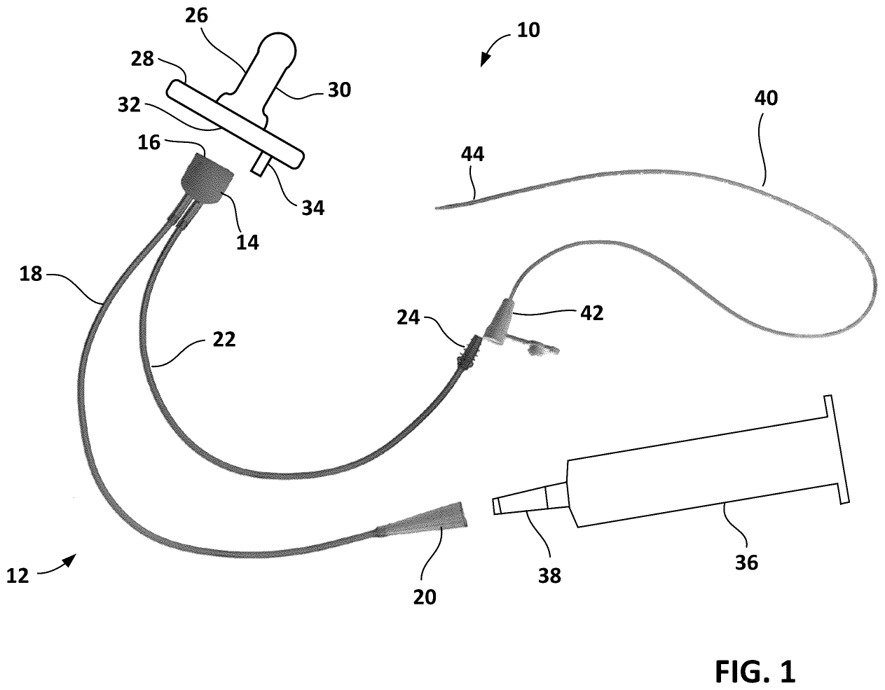

FIG. 1 shows a perspective assembly view of one variation of the pacifier pump system 10 which may include a fluid transfer assembly 12 generally comprised of a flexible housing or hub 14 which defines a receiving channel 16. A length of reservoir tubing 18 may be fluidly coupled to the housing or hub 14 at a first end and terminate in a reservoir connector 20 for removably connecting to the hub 38 of a fluid reservoir 36, e.g., syringe, bag, pouch, or any fluid container. The reservoir connector 20 may be removably connectable to the hub 38 or in other variations, the reservoir connector 20 may be removably or permanently fluidly coupled directly to the fluid reservoir 36. The fluid reservoir 36 itself may include any fluid container which is suitable for storing a fluid (e.g., formula, breastmilk, saline, etc.) which is provided to the infant through the fluid transfer assembly 12.

A length of feed tubing 22 may also be fluidly coupled to the housing or hub 14 at a first end and adjacent to the reservoir tubing 18. The feed tubing 22 may extend from the housing or hub 14 and terminate in a feed connector 24 for removably connecting to the port 42 of a gastric tubing 40 (e.g., nasogastric, orogastric, endoscopic gastrostomy, etc.) which extends for a length and terminates at a distal end 44 defining one or more openings. The gastric tubing 40 may also range in length and diameter depending upon the type of tubing. The length of the feed tubing 22 and length of the reservoir tubing 18 may be varied to be uniform with one another or to have differing lengths relative to one another. The length of the reservoir tubing 18 may extend anywhere between, e.g., 2 to 60 cm, while the length of the feed tubing 22 may extend anywhere between, e.g., 10 to 30 cm. Moreover, the internal diameters of the reservoir tubing 18 and feed tubing 22 may also be the same as one another or varied to be different relative to one another and may range anywhere between, e.g., 1 to 5 mm, to accommodate the desired flow rate and flow volume through the fluid transfer assembly 12.

The receiving channel 16 defined by the housing or hub 14 may be open along the portion of the housing or hub 14 inserted or coupled into the pacifier 26 so that the receiving channel 16 remains open to the interior of the pacifier 26. In other variations (described herein), the receiving channel 16 may be enclosed or partially enclosed within the pacifier 26. The pacifier 26 itself may be a type which is specifically configured or designed for coupling to the housing or hub 14 while in other variations, the pacifier 26 may include a conventional flexible pacifier such as one fabricated from silicone. One example may include the AVENT SOOTHIE Pacifier (Koninklijke Philips N.V.) which is commonly used as a pacifier for newborn infants. Other conventional pacifiers may also be used provided that the nipple is sufficiently flexible and allows for the insertion or coupling of the housing or hub 14. The pacifier 26 shown may include a base or guard 28 and a nipple 30 structure extending from the base or guard 28 for insertion within the mouth of the infant. The nipple 30 is sufficiently compressible and may define an opening 32 through the base or guard 28. An optional projection 34 may also extend from the base or guard 28 or facilitating handling or attachment of various features.

While the fluid transfer assembly 12 is shown and described in one variation as a separate or separable component from the pacifier 26, fluid reservoir 36, and gastric tubing 40, other variations of the pacifier pump system 10 may include a fluid transfer assembly 12 which is integrated with one or more of the other components. For example, the fluid transfer assembly 12 may be integrated with the pacifier 26 so that the gastric tubing 40 and fluid reservoir 36 may be separably attachable. Other variations may include the fluid transfer assembly 12 integrated with the gastric tube 40 so that the pacifier 26 and fluid reservoir 36 are separably attachable. While other variations may include the fluid transfer assembly 12 integrated with the fluid reservoir 36 so that the pacifier 26 and gastric tube 40 are separably attachable. Other variations of the fluid transfer assembly 12 are also intended to be included in any combination as practicable.

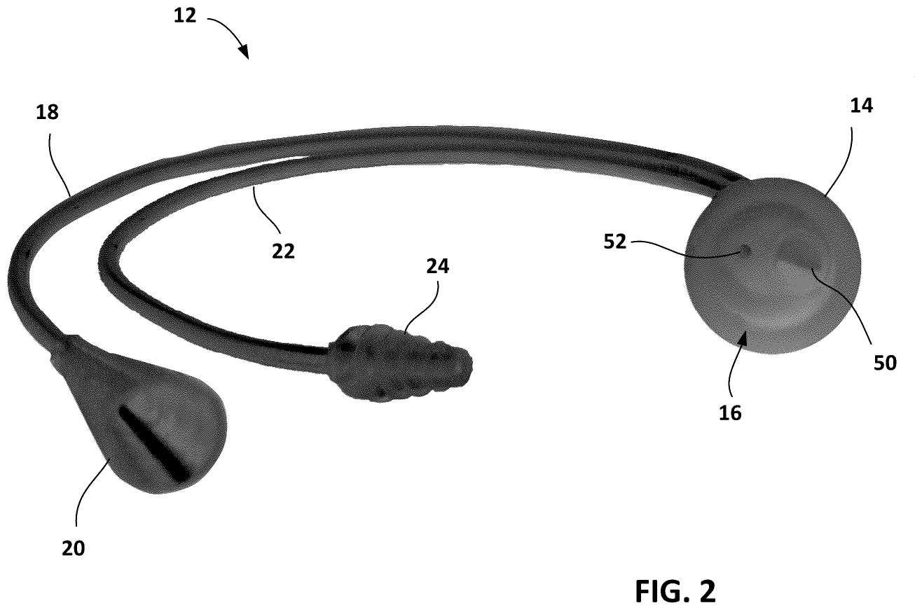

FIG. 2 shows a detail view of one variation of the fluid transfer assembly 12. As illustrated, the housing or hub 14 may include a first valve 50 (e.g., directional valve, check valve, etc.) which is fluidly coupled with the reservoir tubing 18. The reservoir tubing 18 may be fluidly coupled to the housing or hub 14 to extend and terminate in the reservoir connector 20 for fluidly coupling to the fluid reservoir 36. The housing or hub 14 may also include a second valve 52 (e.g., directional valve, check valve, etc.) which is fluidly coupled with the feed tubing 22 which may extend and terminate in the feed connector 24 for fluid coupling to the gastric tube 40.

The first valve 50 may be configured to allow for the directional flow of fluid from the fluid reservoir 36 and within a lumen defined through the reservoir tubing 18, through the first valve 50, and into the interior of the housing or hub 14. The second valve 52 may be configured to allow for the directional flow of the fluid received within the housing or hub 14 to exit through the second valve 52 and into a lumen defined through the feed tubing 22 where the fluid may be urged through the feed connector 24 and into the gastric tube 40 for feeding into the stomach of the infant. The configuration of the first valve 50 and second valve 52 prevents the backflow of the fluid through the housing or hub 14 and further ensures that adequate backpressure is built up through use by the infant, as described in further detail herein.

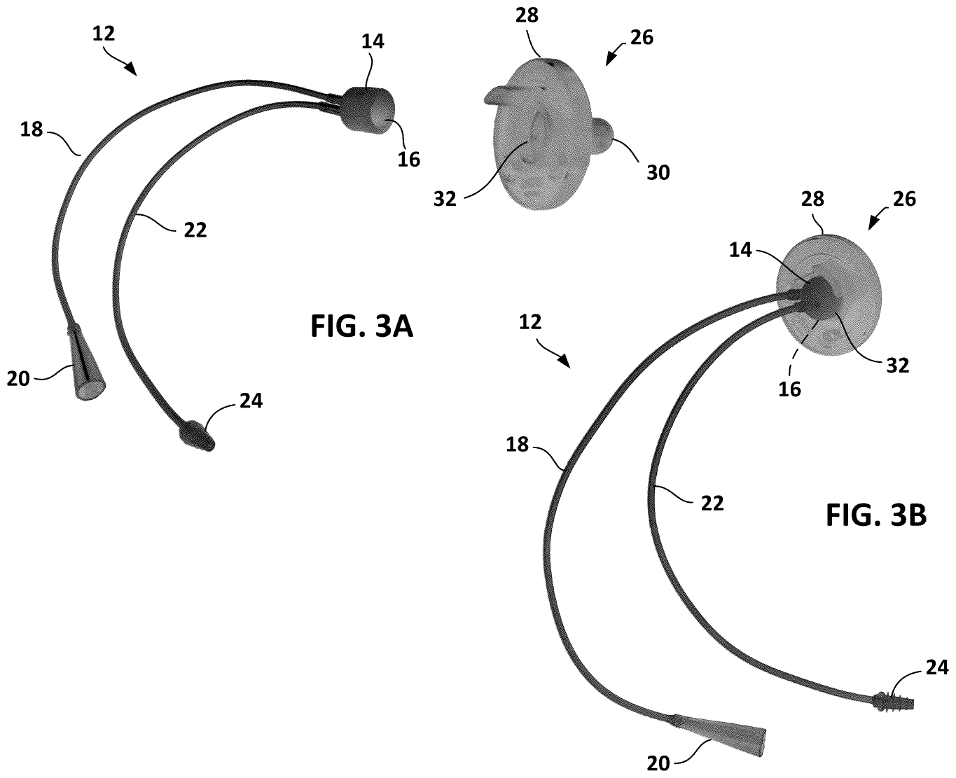

FIGS. 3A and 3B show perspective views of one variation in which the fluid transfer assembly 12 is removably coupled with the pacifier 26. The housing or hub 14 may be configured such that the open receiving channel 16 may be inserted into the opening 32 defined by the pacifier 26 and which extends into the interior of the nipple 30. As the housing or hub 14 may be configured as a flexible structure, the exterior of the housing or hub 14 may have an outer diameter of between, e.g., 1.5 to 2.5 cm, so that the housing or hub 14 may be inserted in a secure fluid-tight attachment within the opening 32 of the pacifier 26. As shown in FIG. 3B, once the housing or hub 14 has been inserted securely within the opening 32, the receiving channel 16 and interior of the nipple 30 may form a fluid chamber for receiving and transferring fluids within.

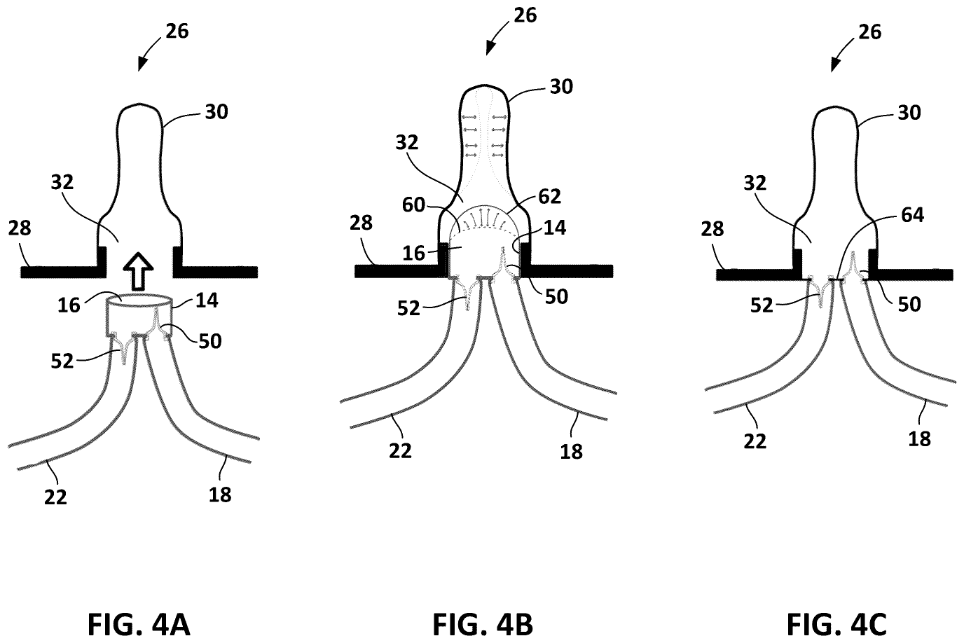

FIG. 4A illustrates a schematic side view of the variation shown in FIGS. 3A and 3B. As shown, the housing or hub 14 may be inserted into a secure engagement with the pacifier 26 in which the outer surface of the housing or hub 14 may inter-fit against the inner surface of the opening 32. The resulting combination of the receiving channel 16 and interior of the nipple 30 may form a fluid-tight chamber into which the first valve 50 and second valve 52 may regulate the introduction and removal of fluid via the respective reservoir tubing 18 and feed tubing 22.

FIG. 4B illustrates yet another variation in the schematic side view in which the housing or hub 14 may be securely retained within base 28 and may further include a flexible membrane or diaphragm 62 which encapsulates receiving channel 16 into a relative smaller volume than the channel defined within opening 32 of nipple 30. As the structure of the nipple 30 compresses and expands due to the sucking action of the infant, the compression and expansion of the air trapped within the opening 32 may force the membrane or diaphragm 62 to expand from its resting state 60 thereby creating a negative pressure within the housing or hub 14 to draw in and force out the fluid. However, due to the relatively smaller volume defined by the interior of the housing or hub 14 and membrane or diaphragm 62, a smaller pressure differential may be needed to pump the fluid through the assembly thereby reducing the amount of pressure needed by the sucking actuation.

FIG. 4C illustrates yet another variation in the schematic side view in which the base 28 of the pacifier 26 may be configured to provide an integrated base 64. In this variation, the housing or hub 14 may be omitted and the first valve 50 and second valve 52 may be formed directly into the base 64 which is integrated directly with the pacifier 26. The respective reservoir tubing 18 and feed tubing 22 may also be formed directly with the base 64 or they may be attached or secured directly to the base 64 rather than a separately removable housing or hub.

During use, the pumping action upon the fluid may be functionally provided directly by the sucking motion of the infant upon the nipple 30 of the pacifier 26. The pacifier 26 may be provided to the infant just prior to feeding so that the infant may begin sucking upon the nipple 30 or the pacifier 26 may be provided several minutes prior to feeding. The hub or housing 14 may be coupled to the pacifier prior to the infant sucking upon the pacifier 26 or the hub or housing 14 may be coupled just prior to feeding while the infant retains the pacifier 26. The gastric tube 40 may be inserted intra-orally or intra-nasally (or percutaneously) prior to the feeding of the infant in a separate procedure. In either case, the feed tubing 22 may be pre-coupled to the gastric tube 40 or the feed tubing 22 may be coupled to the gastric tube 40 just prior to feeding of the infant.

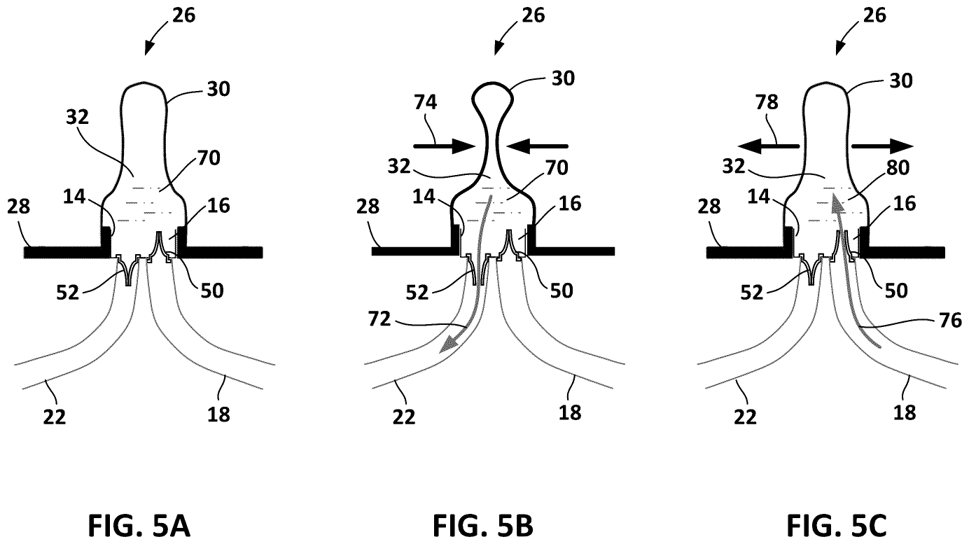

A first bolus of fluid 70 may be introduced from the fluid reservoir 36, through the reservoir tubing 18 and first valve 50, and into the opening 32 within the pacifier 26, as shown in the schematic side view of FIG. 5A. The first bolus 70 may be introduced by forcing the fluid from the fluid reservoir 36 (e.g., via a plunger, compression, etc.) or the first bolus 70 may be introduced within the pacifier 26 by the sucking action of the infant. The first bolus 70 may pass through the first valve 50 and may be prevented from flowing backwards into the reservoir tubing 18 by the valve 50. As the infant begins or continues to suck upon the nipple 30, the nipple structure may deform and compress during its manipulation by the mouth of the infant during sucking. FIG. 5B shows a schematic side view in which the compression 74 of the nipple 30 by the infant's mouth may force the first bolus 70 contained within the opening 32 of the nipple 30 in an outward flow 72 from the pacifier 26 and through the second valve 52 and through the feed tubing 22. Backwards flow of the fluid back through the reservoir tubing 18 may be prevented by the first valve 50 closing. The bolus 70 may empty from the pacifier 26 and flow through the feed tubing 22 and into the gastric tube 40 for directly feeding the infant.

As the nipple 30 re-expands or re-forms into its original shape, as indicated by the direction of expansion 78, a negative pressure may form within the pacifier 26 and the second valve 52 may then close and the first valve 50 may then re-open to allow for an inflow 76 of fluid within the opening 32 of the nipple 30 from the fluid reservoir 36 such that a second bolus 80 may then be retained within the pacifier 26, as shown in FIG. 5C. Continued sucking motion by the infant may repeat the process to functionally pump the fluid into and out of the pacifier 26 for feeding the infant so long as the infant continues to suck. Once the infant has been satiated and ceases to suck upon the nipple 30, the pumping of the fluid may likewise cease. Alternatively, the pumping of the fluid may be stopped manually by the caretaker.

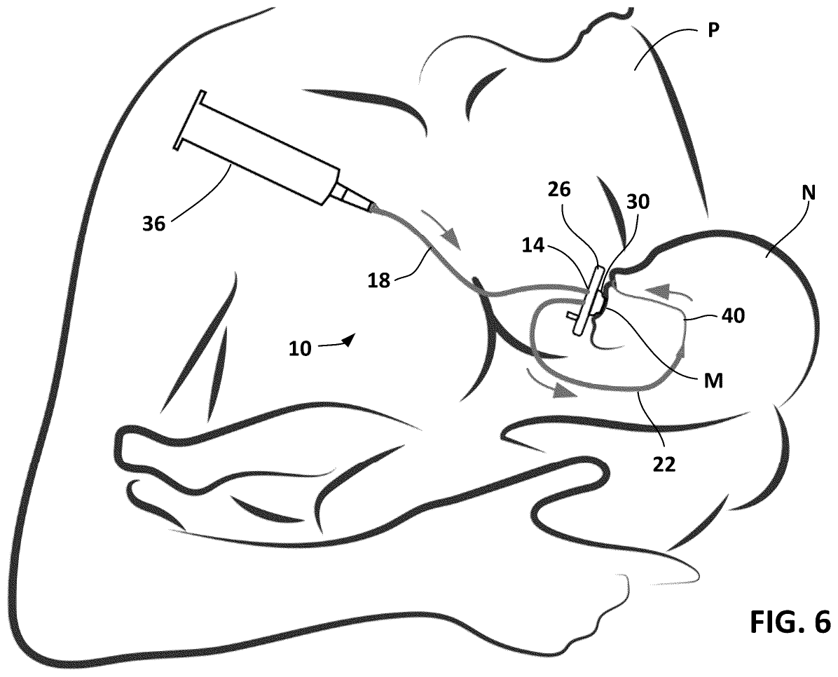

FIG. 6 illustrates one example of how the pacifier pump system 10 may be utilized for feeding an infant N. In this example, the infant N may be held by a parent or caretaker P as if feeding the infant N normally. The housing or hub 14 of the fluid transfer assembly 12 may be fluidly coupled to the pacifier 26 and the reservoir tubing 18 may be attached to the fluid reservoir 36 which may be held separately, placed upon the parent or caretaker P, hung upon a hook or other structure, or otherwise positioned into proximity of the infant N. The gastric tube 40 may be inserted into the infant N prior to feeding and otherwise secured to the infant N such as with an adhesive tape or other mechanism. The gastric tube 40 may be fluidly coupled to the feed tubing 22 with the nipple 30 of the pacifier 26 retained within the mouth M of the infant N.

As the infant N begins or continues to suck upon the nipple 30, the fluid within the fluid reservoir 36 may be drawn through the reservoir tubing 18 by the pumping action of the pacifier as provided by the sucking motion of the infant N, as described herein. The bolus of fluid may pass through the pacifier 26 and into the feed tubing 22 where it may then pass through the gastric tube 40 and into the infant for feeding. Once the infant N has stopped sucking, the pumping action of the pacifier 26 may likewise cease to halt feeding of the infant N. The feed tubing 22 may be optionally de-coupled from the gastric tube 40 and the pacifier 26 removed from the mouth M of the infant N. The fluid reservoir 36 may also be removed and optionally de-coupled from the reservoir tubing 18. The hub or housing 14 may also be optionally removed from the pacifier 26 for disposal or sterilization.

As described hereinabove, the system may be primed by forcing the fluid from the fluid reservoir 36 by using, e.g., a plunger, compression, etc., in order to introduce a first bolus 70 of fluid within the pacifier 26 by reducing the initial pressure differential that the infant must overcome by sucking upon the nipple 30. In such an embodiment, the fluid reservoir 36 may utilize a plunger to impart the pressure increase upon the fluid to force the fluid initially through the reservoir tubing 18 and/or feed tubing 22. The plunger may be depressed and maintained in place such that the increased pressure level remains constant. As the infant sucks upon the fluid, the reduction of pressure within the system may be increased again by further depressing upon the plunger.

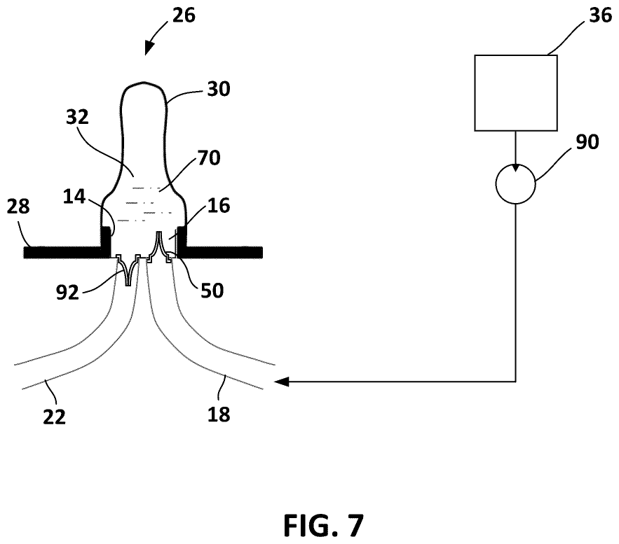

Another variation may include the integration of an adjustable pressure component 90 in fluid communication with the fluid reservoir 36, as shown in schematic view of FIG. 7. The adjustable pressure component 90 may include any variety of pump such as peristaltic pump which may be used to maintain an increased pressure level upon the fluid. Furthermore, the adjustable pressure component 90 may be placed anywhere along the reservoir tube 18 or it may be integrated directly with the fluid reservoir 36 itself.

In either variation with the use of a plunger or a pump, the infant may suck upon the nipple 30 to further increase the pressure level within the nipple 30 such that the second valve 92 may open to release the bolus of fluid within. The second valve 92 may accordingly be configured to have a relatively greater opening pressure to accommodate the pressure increase from the plunger or pump in addition to the pressure generated by the infant sucking upon the nipple 30. Despite the implementation of an increased pressure upon the fluid itself, the use of the second valve 92 may meter the fluid release into the feed tubing 22 such that the infant does not experience the pressure rise directly during feeding.

While illustrative examples are described above, it will be apparent to one skilled in the art that various changes and modifications may be made therein. As previously described, each and every feature described may be used in any number of combinations as practicable. Moreover, various apparatus or procedures described above are also intended to be utilized in combination with one another, as practicable. The appended claims are intended to cover all such changes and modifications that fall within the true spirit and scope of the invention.

What is claimed is:

1. A method of feeding an infant, comprising:
fluidly coupling a housing or hub within an opening of a pacifier;
fluidly coupling a reservoir tubing extending from the housing or hub to a fluid reservoir;
fluidly coupling a feed tubing extending from the housing or hub to a gastric tube extending into the infant; and
positioning the pacifier within a mouth of the infant, wherein a sucking motion provided by the infant upon a nipple of the pacifier actuates a fluid within the fluid reservoir to flow through the reservoir tubing, into the housing or hub, through the feed tubing, and into the gastric tube to provide the fluid to the infant.

2. The method of claim 1 wherein fluidly coupling the housing or hub comprises inserting the housing or hub within the opening of the pacifier.

3. The method of claim 1 wherein fluidly coupling the reservoir tubing comprises fluidly coupling through a first unidirectional valve which enables flow from the reservoir tubing into the housing or hub.

4. The method of claim 1 wherein fluidly coupling the reservoir tubing comprises fluidly coupling the reservoir tube to a hub of a syringe.

5. The method of claim 1 wherein fluidly coupling the feed tubing comprises fluidly coupling through a second unidirectional valve which enables flow from the housing or hub into the feed tubing.

6. The method of claim 1 wherein the gastric tube comprises a nasogastric or orogastric tube.

7. The method of claim 1 wherein the sucking motion provided by the infant comprises a compression and decompression of the nipple of the pacifier.

8. The method of claim 1 further comprising imparting a pressure upon the fluid.

9. A method of associating feeding in an infant, comprising:
providing a pacifier positioned within a mouth of the infant, wherein the pacifier is fluidly coupled to a fluid reservoir and also to a gastric tube extending into the infant;
providing a fluid within the fluid reservoir, wherein the fluid is actuated to flow from the fluid reservoir, through the pacifier, and to the gastric tube when the infant sucks upon the pacifier.

10. The method of claim 9 wherein providing the pacifier comprises inserting a housing or hub within an opening of a pacifier.

11. The method of claim 10 further comprising fluidly coupling the pacifier to the fluid reservoir through a reservoir tubing.

12. The method of claim 11 wherein fluidly coupling the pacifier further comprises fluidly coupling the reservoir tubing through a first unidirectional valve which enables flow from the reservoir tubing into the housing or hub.

13. The method of claim 11 further comprising fluidly coupling the reservoir tubing to a hub of a syringe.

14. The method of claim 11 further comprising fluidly coupling the pacifier to the gastric tube through a feed tubing.

15. The method of claim 14 wherein fluidly coupling the pacifier further comprises fluidly coupling the feed tubing to the housing or hub through a second unidirectional valve which enables flow from the housing or hub into the feed tubing.

16. The method of claim 9 wherein the gastric tube comprises a nasogastric or orogastric tube.

17. The method of claim 9 wherein the sucking motion provided by the infant comprises a compression and decompression of a nipple of the pacifier.

18. The method of claim 9 further comprising imparting a pressure upon the fluid as the infant sucks upon the pacifier.

19. A pacifier pump system, comprising:
a housing or hub defining a receiving channel and having a first valve and a second valve, wherein the housing or hub is configured to be removably coupled to an opening defined within a pacifier;
a reservoir tubing fluidly coupled to the receiving channel through the first valve which is configured to enable flow from the reservoir tubing into the receiving channel; and
a feed tubing fluid coupled to the receiving channel through the second valve which is configured to enable flow from the receiving channel into the feed tubing.

20. The system of claim 19 wherein the housing or hub forms an enclosure between the receiving channel and the opening defined within the pacifier.

21. The system of claim 19 further comprising a fluid reservoir which is removably attachable to the reservoir tubing.

22. The system of claim 19 further comprising a gastric tube which is removably attachable to the feed tubing.

23. The system of claim 19 wherein the first valve comprises a unidirectional valve which enables unidirectional flow from the reservoir tubing into the receiving channel.

24. The system of claim 19 wherein the second valve comprises a unidirectional valve which enables unidirectional flow from the receiving channel into the feed tubing.

25. The system of claim 19 further comprising a mechanism for imparting a pressure upon a fluid within the pacifier.
